(19) United States
(12) Patent Application Publication
(10) Pub. No.: US 2022/0258442 A1
(43) Pub. Date: Aug. 18, 2022

(54) METHOD AND DEVICE FOR PRODUCING GREEN TYRES

(71) Applicant: HARBURG-FREUDENBERGER MASCHINENBAU GMBH, Hamburg (DE)

(72) Inventors: Achim BEHRENS, Asendorf (DE); Ulrich BUSCH, Hamburg (DE)

(21) Appl. No.: 17/624,639

(22) PCT Filed: May 26, 2020
(86) PCT No.: PCT/DE2020/100445

§ 371 Date: Jan. 4, 2022

(30) Foreign Application Priority Data
Jul. 18, 2019 (DE) 10 2019 119 474.1

(51) Int. Cl. B29D 30/30; B29D 30/24

(52) U.S. Cl. CPC B29D 30/30; B29D 30/245

(57) ABSTRACT

A method and a tire construction machine for producing green tires, it being possible to produce green tires with a SOT (sidewall over tread) construction and high turn-up of at least one ply. The tire construction machine has a redesigned side wall server.

The invention relates to a method for producing green tires in which a green tire is produced by means of a tire building machine on at least one tire building drum from multiple plies.

The invention also relates to a device for producing green tires in the sense of a tire building machine for producing green tires from multiple plies.

Such tire building machines generally have at least one tire building drum and so-called servers, with which the various plies of a green tire can be applied to the tire building drum(s), so that the green tire can be produced from them.

Corresponding tire building machines are known for example from DE 10 2018 003 301.6.

The green tires are generally built up from a plurality of plies which are partially turned up around two annular cores and in a later method step are connected to a separately produced breaker belt assembly and a tread. Furthermore, the green tires have sidewalls, which are connected as separate elements to the rest of the green tire. Depending on whether the tread of the green tire overlaps the sidewalls or the sidewalls of the green tire overlap the tread, the tire is differentiated as being of a TOS (tread over sidewall) construction or SOT (sidewall over tread) construction.

It is also possible to reinforce the sidewalls of a tire in a material-saving way by at least one ply being turned up around the cores and laid double in the sidewall region, instead of introducing a second complete ply into the green tire. Such tires are referred to as tires with a high turn-up (or else C-ply) of at least one ply.

The fully automated production of the combination of SOT green tires with at least one ply formed as a high turn-up is not yet possible according to the prior art.

Rather, manual interventions are still required for this to a considerable extent in production.

One object of the invention is therefore that of providing a device for producing green tires in the sense of a tire building machine with which the production of SOT green tires with at least one ply formed as a high turn-up is made possible.

This object is achieved according to the invention by a device for producing tires having the features according to patent claim 1.

A further object of the invention is that of providing a method for producing green tires with which the production of SOT green tires with at least one ply formed as a high turn-up is made possible.

This object is achieved according to the invention by a method for producing green tires having the features according to patent claim 5.

The features disclosed below of a device for producing tires in the sense of a tire building machine are part of the invention both individually and in all feasible combinations.

A device according to the invention for producing tires is formed as a tire building machine, which has at least one tire building drum, a ply server and a sidewall server.

In one embodiment of the invention, the tire building drum has a middle part and two drum halves, which are arranged next to the middle part in the axial direction and are arranged with the middle part on a common drum shaft.

In a preferred embodiment of the invention, the drum halves can be moved in relation to the middle part in the axial direction on the drum shaft, so that they can be positioned directly next to the middle part or at a distance from the middle part.

In one embodiment of the invention, the middle part of the tire building drum can be expanded in the radial direction, so that the circumference and the diameter of the middle part can be set.

Furthermore, in a preferred embodiment of the invention, the width of the middle part of the tire building drum can be set.

In one embodiment of the invention, the middle part of the tire building drum is for this purpose divided in two, wherein the modules of the middle part can be moved in relation to one another in the axial direction of the drum shaft.

In a particularly preferred embodiment of the invention, the modules of the middle part are of a finger-like design, wherein the fingers of the modules of the middle part are arranged engaging in one another.

In a preferred embodiment of the invention, the tire building drum has a core clamping device, with which the cores of a green tire can be fixed in a clamping manner on the tire building drum.

In a preferred embodiment of the invention, the core clamping device of the tire building drum has for this purpose radially extendable shoulders, with which the cores can be clamped from inside.

In a further embodiment of the invention, the tire building machine has in the region of the tire building drum at least one turning-up device, with which the plies of the green tire can be turned up around the cores and/or can be pressed against the other plies of the green tire.

In a preferred embodiment of the invention, the tire building machine has two turning-up devices, with which the plies can be turned up around and pressed against both sides of a green tire at the same time.

In one embodiment of the invention, the turning-up devices are formed as expandable bladders.

In a further embodiment of the invention, the turning-up devices have turning-up fingers and/or rollers.

In a preferred embodiment of the invention, the turning-up devices are arranged in the region of the drum halves of the tire building drum.

In a further embodiment of the invention, the tire building machine has in the region of the tire building drum an air-introducing device for introducing air into the green tire.

In one embodiment, the tire building drum can be rotated by means of a drive device.

In a further embodiment of the invention, the tire building drum can be moved together with the drum shaft at least in the axial direction of the drum shaft in the region of the tire building machine, so that the tire building drum can be positioned in the working area of various items of equipment of the tire building machine.

Such an item of equipment is for example the ply server. With the ply server, the various plies of a green tire can be transferred onto the tire building drum.

In a further embodiment of the invention, the tire building machine has a core setting device. By means of the core setting device, the annular cores of the green tire can be set.

In one embodiment of the invention, the core setting device is arranged in the region of a further item of equipment of the tire building machine, which is referred to below as the tire building ring.

In one embodiment of the invention, in the working area of the tire building ring the cores can consequently be set.

In a further embodiment of the invention, in the working area of the tire building ring the breaker belt assembly and the tread of the green tire can be connected to the plies of the rest of the green tire built up on the tire building drum.

In one embodiment of the invention, it has a pressure-exerting device for pressing the breaker belt assembly and the tread against the rest of the green tire.

In a preferred embodiment of the invention, the pressure-exerting device for the breaker belt assembly and the tread is arranged in the working area of the tire building ring.

In one embodiment of the invention, the breaker belt assembly can be produced separately on a belt drum, onto which the various plies of material of the breaker belt assembly and also the tread can be transferred by means of at least one tread server.

In a preferred embodiment of the invention, the belt drum can be moved out of the working area of the tread server into the working area of the tread building ring.

In a preferred embodiment of the invention, it has a sidewall server, with which the material for the sidewalls of the green tire can be transferred onto the tire building drum.

In a particularly advantageous embodiment of the invention, the sidewall server is divided in two, so that the material for both sidewalls of a green tire can be transferred at the same time to the tire building drum.

In a further preferred embodiment of the invention, the sidewall server is in this case formed in such a way that with it the material for one sidewall in each case can be transferred to one drum half each of the tire building drum, wherein the drum halves can be positioned at a distance in relation to the middle part of the tire building drum.

In one embodiment of the invention, the sidewall server has for this purpose a sidewall server module for each sidewall, wherein these sidewall server modules are at approximately the same distance from one another perpendicularly to the transporting direction of the material, for instance parallel to the direction of longitudinal extent of the drum shaft, as the drum halves, which are positioned at a distance in relation to the middle part of the tire building drum.

In a particularly preferred embodiment, the ply server is used as a sidewall server module.

The features disclosed below of a method for producing green tires are part of the invention both individually and in all feasible combinations.

A method according to the invention for producing green tires comprises the following steps:
1. Positioning a first ply (inner liner) of the green tire centrally on the tire building drum
2. Positioning a second ply over the first ply centrally on the tire building drum (body ply)
3. Expanding the middle part in the radial direction
4. Setting cores
5. Clamping cores
6. Turning up the ply (plies) around the cores
7. Transferring the material for the sidewalls of the green drum onto one drum half each, wherein the drum halves are positioned at a distance in relation to the middle part of the tire building drum
8. Moving the drum halves toward the middle part, so that the sidewall material is positioned in some regions under the cores of the green tire
9. Pressing the sidewall material under the cores
10. Introducing air into the green tire (carcass)
11. Positioning and pressing the breaker belt assembly and the tread against the rest of the green tire
12. Pressing the sidewalls against the green tire, so that in some regions they overlap the tread

The list given above is a non-exhaustive enumeration of method steps of a method according to the invention for producing tires. Carrying out the method steps listed is however sufficient for the production of green tires according to one exemplary embodiment.

Further method steps may be in particular the transport of the tire building drum to the tire building ring and/or to the ply or sidewall server, the production of the breaker belt assembly on a belt drum, and also the transport of the breaker belt assembly and the tread to the tire building ring.

In a method according to the invention for producing tires, at least one ply (body ply) is formed with a high turn-up. For this purpose, the corresponding ply is made at least wide enough that, after the turning up, it lies in contact further around the green tire lying thereunder than the sidewall material when it has been pressed on directly against the same inner ply lying under the ply formed with a high turn-up (body ply).

A ply formed with a high turn-up (body ply) of the green tire brings about a reinforcement of the sidewalls of the tire while at the same time saving material in the middle region of the tire in comparison with an additional ply (body ply) by the fact that, as a result of the turned-up regions of the ply formed with a high turn-up (body ply), not the entire middle region of the green tire is covered. An additional reinforcement by a ply (body ply) is not generally required in the middle region of the tire.

In a preferred embodiment of the method according to the invention for producing tires, a device according to the invention for producing tires is used.

According to the invention, a different number of plies may also be used for producing the green tire. Preferably, more plies are used for producing a green tire.

In the following figures, possible forms of construction of green tires of the SOT construction with a high turn-up of a ply and the method steps of an embodiment according to the invention of a method for producing green tires are shown by way of example. In the figures:

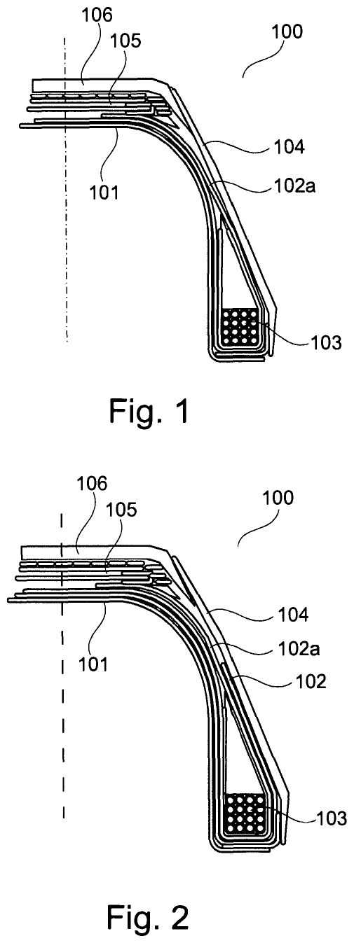

FIG. 1: shows a partial view of a section of one variant of a tire of the SOT construction with a high turn-up of a ply,

FIG. 2: shows a partial view of a section of a further variant of a tire of the SOT construction with a high turn-up of a ply,

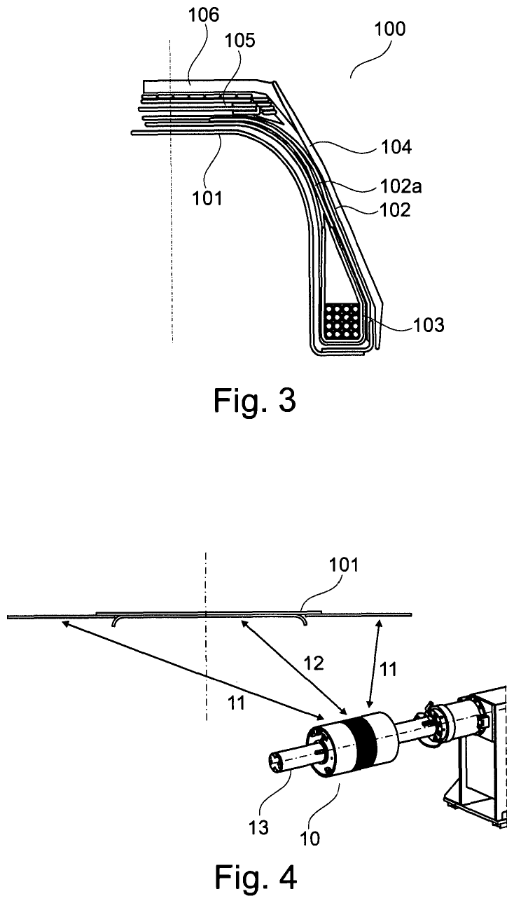

FIG. 3: shows a partial view of a section of a further variant of a tire of the SOT construction with a high turn-up of a ply,

FIG. 4: shows a schematic representation of the positioning of a first ply (inner liner) on a tire building drum and a perspective view of a tire building drum,

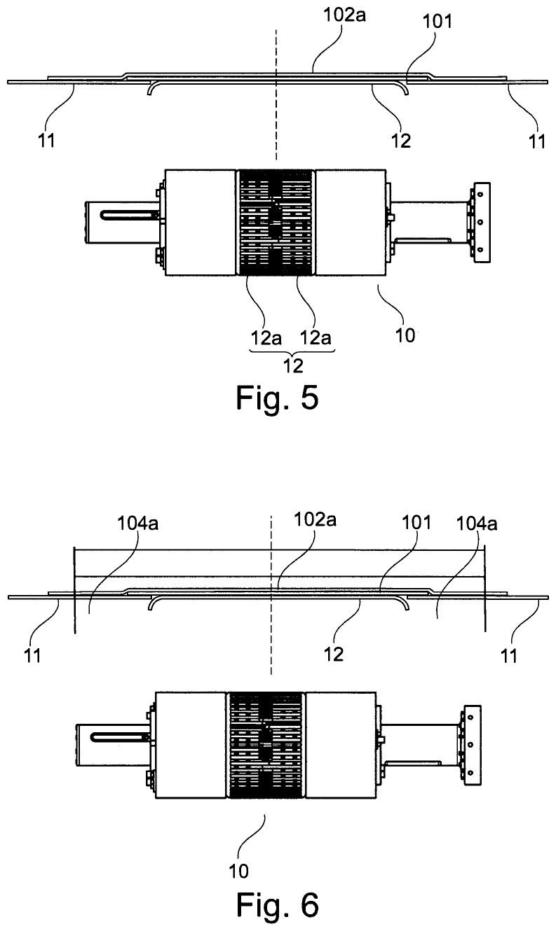

FIG. 5: shows a schematic representation of the positioning of a second ply (body ply) on a tire building drum and a side view of a tire building drum,

FIG. 6: shows the representation from FIG. 5, with the position of the outer ends of the sidewall material indicated,

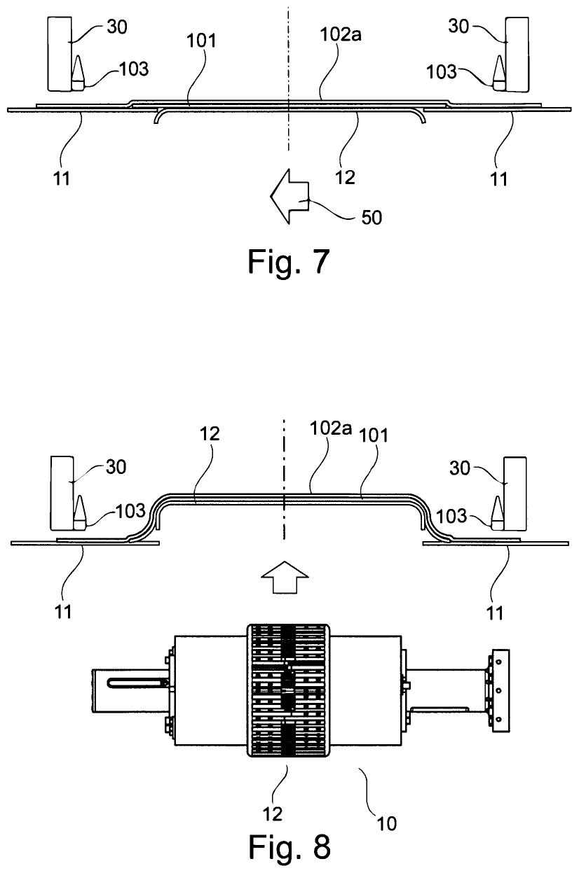

FIG. 7: shows a schematic view of a detail of the tire building drum in the region of the core setting device,

FIG. 8: shows a schematic representation of a detail of the tire building drum in one method step during the core setting and a side view of a tire building drum,

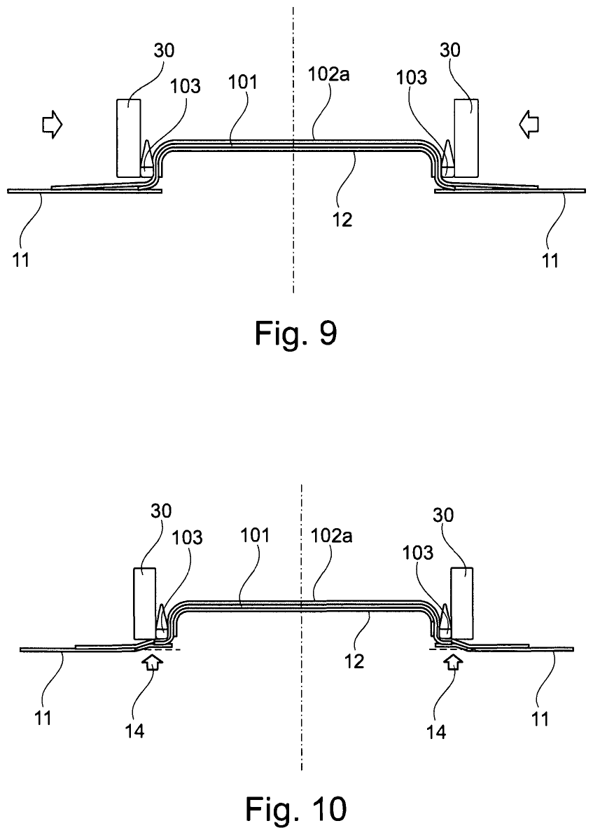

FIG. 9: shows a schematic representation of a detail of the tire building drum in a further method step during the core setting,

FIG. 10: shows a schematic representation of a detail of the tire building drum during the core clamping,

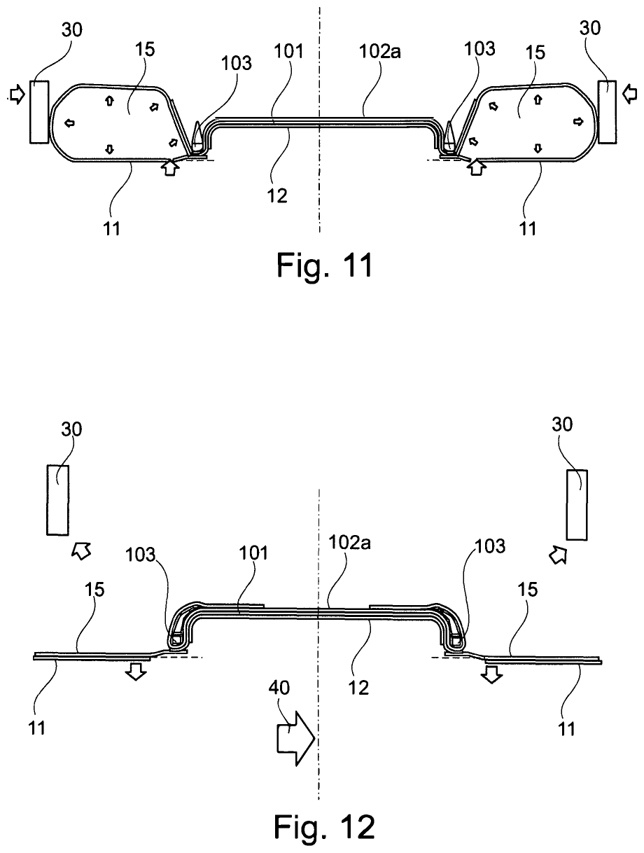

FIG. 11: shows a schematic representation of a detail of the tire building drum during the ply turning-up,

FIG. 12: shows a schematic representation of a detail of the tire building drum after the ply turning-up,

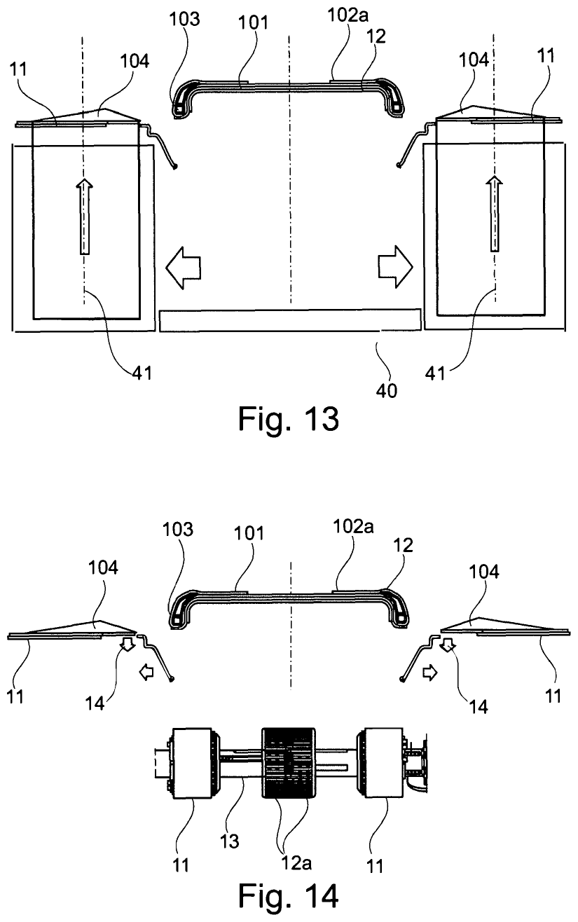

FIG. 13: shows a schematic representation of a detail of the tire building drum during the transfer of the sidewall material from two sidewall servers of a tire building machine according to the invention,

FIG. 14: shows a schematic representation of a detail of the tire building drum after the transfer of the sidewall material onto the tire building drum and a side view of a tire building drum,

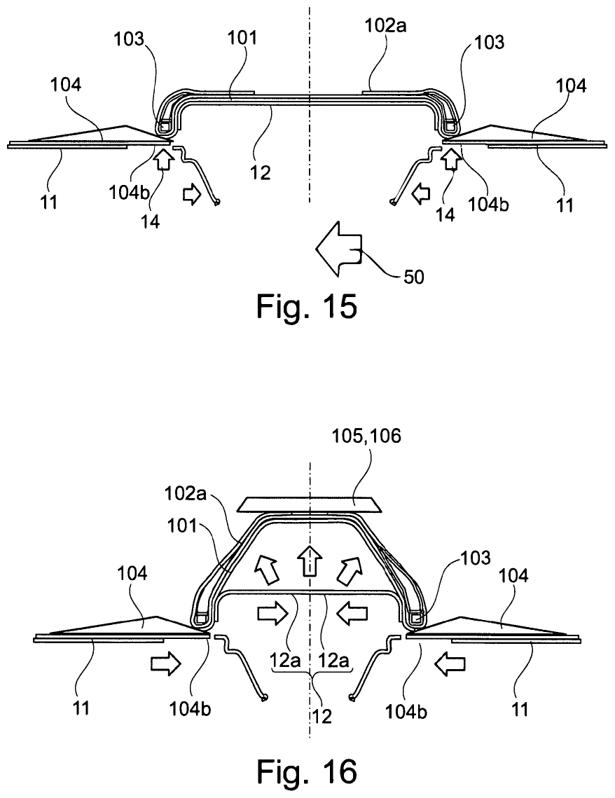

FIG. 15: shows a schematic representation of a detail of the tire building drum during the production of a green tire,

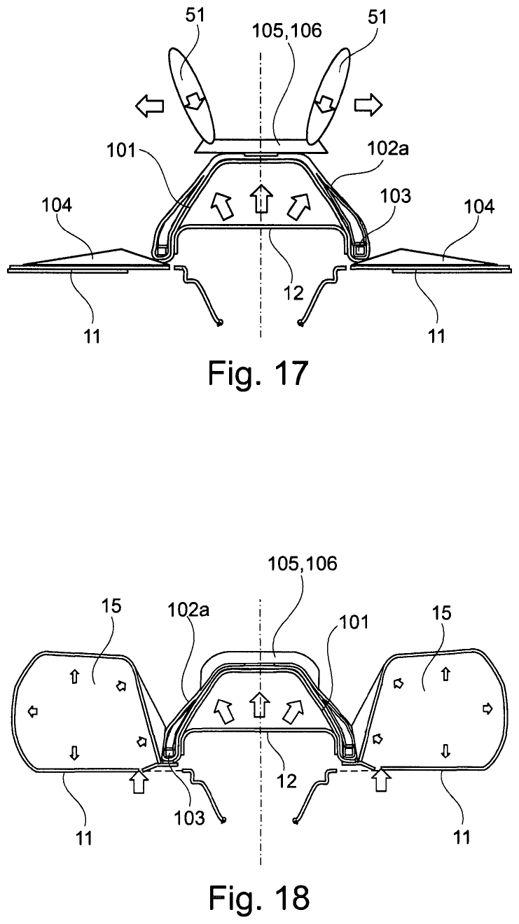

FIG. 16: shows a schematic representation of a detail of the tire building drum before the connection of the breaker belt assembly to the rest of the green tire, FIG. 17: shows a schematic representation of a detail of the tire building drum during the connection of the breaker belt assembly to the rest of the green tire,

FIG. 18: shows a schematic representation of a detail of the tire building drum during the pressing of the sidewalls against the rest of the green tire,

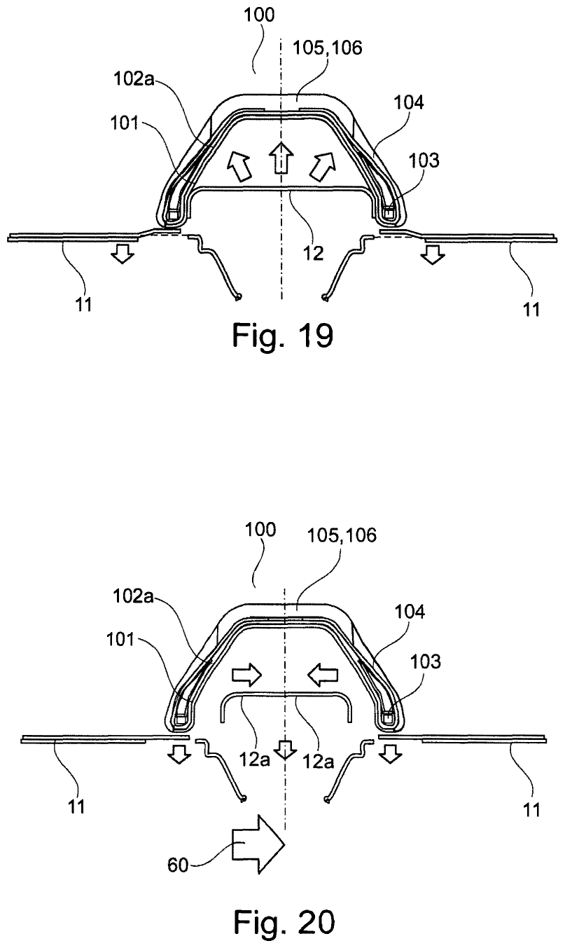

FIG. 19: shows a schematic representation of a detail of the tire building drum after the pressing of the sidewalls against the rest of the green tire and

FIG. 20: shows a schematic representation of a detail of the tire building drum after the completion of the green tire before the transfer to an unloading device.

In FIG. 1, a partial view of a section of one variant of a green tire (100) of the SOT construction with a high turn-up of a ply is shown. The green tire (100) has on the inside a first ply, referred to as an inner liner (101), on which a body ply (102a) has been applied as a second ply with a high turn-up. The body ply with a high turn-up (102a) has in this case been turned up around a core (103), wherein the turned-up region of the body ply with a high turn-up (102a) extends through the entire sidewall region of the green tire (101) into the middle region of the green tire (100). There, the body ply with a high turn-up (102a) ends at a distance from the axis of symmetry, represented by dashed lines, of the green tire (100).

This distance defines the amount of material saved in comparison with the use of a further complete body ply (102) for reinforcing the tire in the sidewall region. Furthermore, the green tire (100) has a sidewall (104), a breaker belt assembly (105), which is provided by the multiple plies arranged over the body ply with a high turn-up (102a), and a tread (106). In the SOT construction shown of the green tire (100), the material of the sidewall (104) overlaps the material of the tread (106).

FIG. 2 shows a partial view of a section of a further variant of a green tire (100) of the SOT construction with a high turn-up of a ply. In comparison with the variant shown in FIG. 1, this green tire (100) has an additional ply, which is realized by the body ply (102) without a high turn-up.

In FIG. 3 a partial view of a section of a further variant of a green tire (100) of the SOT construction with a high turn-up of a ply is shown, wherein the green tire (100) has an additional ply in comparison with FIG. 1, realized by the body ply, which has been pressed downward onto the plies lying thereunder.

FIG. 4 shows a schematic representation of a method step of a method according to the invention for producing green tires (100) in the form of the positioning of the inner liner (101) as a first ply on a tire building drum (10) and underneath it a perspective view of a tire building drum (10). The tire building drum (10) has a middle part (12) and two drum halves (11), arranged next to the middle part (12), and is mounted on a drum shaft (13). The radial axis of symmetry of the tire building drum (10) is indicated by dashed lines. The inner liner (101) can be applied centrally to the tire building drum (10) by means of a ply server (20), which is not shown.

In FIG. 5, a schematic representation of the positioning of the body ply (102) as a second ply on a tire building drum (10) and a side view of a tire building drum (10) are shown. The body ply (102) can be applied centrally to the tire building drum (10), with the inner liner (101) already lying on it, by means of the ply server (20).

FIG. 6 shows the representation from FIG. 5 with the position of the outer ends (104a) of the sidewall material (104) indicated to illustrate the amount of setting of the plies. The material of the body ply (102) protrudes beyond the position of the outer ends (104a) of the sidewall material (104), so that a body ply with a high turn-up (102a) can be realized.

In FIG. 7, a schematic view of a detail of the tire building drum (10) in the region of the core setting device (30) is shown. In this method step, preparations are made for the setting of the cores (103). In the exemplary embodiment shown of the invention, the core setting device (30) is arranged in the region of the tire building ring (50), so that the tire building drum (10) is first transferred out of the region of the ply server (20) into the region of the tire building ring (50), which is illustrated by the arrow under the schematic representation of the tire building drum (10). The cores (103) are held by the core setting device (30).

FIG. 8 shows a further method step of a method according to the invention for producing green tires in connection with the setting of the cores (103). The tire building drum (10) is also arranged in the region of the tire building ring (50) and the core setting device (30) and the middle part (12) is expanded in the radial direction. The cores are still held by the core setting device (30).

In FIG. 9, a following method step of a method according to the invention for producing green tires in connection with the setting of the cores (103) is shown. The cores (103) are brought up to the plies (101, 102a) lying on the middle part (12) of the tire building drum (10) from outside by means of the core setting device (30).

FIG. 10 shows the clamping of the previously positioned cores (103), following the method step shown in FIG. 9, by means of radially extendable core clamping devices (14), which are arranged in the region of the drum halves (11).

In FIG. 11, the method step of the ply turning-up, taking place after the core setting, is shown. The plies (101, 102) are turned up around the cores (103) and pressed against them by means of turning-up devices (15) formed as bladders, which are respectively arranged in the region of a drum half (11). For this purpose, air is introduced into the bladders (15), so that they expand. The core setting device (30) is in this case used for shaping the turning-up devices (15) formed as bladders. For this purpose, the core setting device (30) can in each case be brought up to the expanding or expanded bladders from outside, so that a force acting in the direction of the middle part (12) of the tire building drum (10) is exerted on the bladders.

FIG. 12 shows the partially produced green tire (100) after the ply turning-up described above. The inner liner (101) and the body ply (102a) have been turned up around the cores (103) and pressed against them. The core setting device (30) is moved back away from the tire building drum (10) and the turning-up devices (15) are returned, in the exemplary embodiment shown by letting air out of the bladders. The tire building drum (10) is transferred, with the green tire (100) produced to this extent, to the sidewall server (40).

In FIG. 13, a schematic representation of a detail of the tire building drum (10) during the transfer of the sidewall material from a two-part sidewall server (40) of a tire building machine according to the invention is shown. The sidewall server modules (41) are spaced apart from one another in such a way that the sidewall material of one side wall (104) each of the green tire (100) can be applied to a drum half (11) in each case by a sidewall server module (41), wherein the drum halves (11) have been moved on the drum shaft (13) into a position at a distance from the middle part (12) of the tire building drum (10).

FIG. 14 shows the schematic representation shown in FIG. 13 of a detail of the tire building drum (10) during the transfer of the sidewall material from a two-part sidewall server (40) of a tire building machine according to the invention and underneath it a side view of a tire building drum (10). The drum halves (11) have been moved on the drum shaft (13) into a position at a distance from the middle part (12) of the tire building drum (10) and the core clamping device (14) has been moved in. The middle part (12) of the tire building drum (10) is still expanded in the radial direction.

In FIG. 15, a schematic representation of a detail of the tire building drum (10) in a further method step of a method according to the invention for producing green tires (100) is shown. The tire building drum (10) has been transferred into the working area of the tire building ring (50). The drum halves (11), loaded with the sidewalls (104), are moved in the direction of the middle of the drum, shown by dashed lines, so that the material of the sidewalls (104) in an end region (104b) lies under the cores (103) of the rest of the green tire (100) held on the middle part (12) of the tire building drum (10). Subsequently, the end regions of the sidewalls (104), positioned under the cores (103), are pressed against the green tire (100) by the core clamping device (14), by extending the same under the cores (103).

FIG. 16 shows a schematic representation of a detail of the tire building drum (10) in a further method step of a method according to the invention for producing green tires (100). The tire building drum (10) is still positioned in the working area of the tire building ring (50). The modules (12a) of the middle part (12) are moved together in the axial direction, so that the width of the middle part (12) is reduced, and the drum halves (11) are moved to the same extent in the direction of the middle of the drum, represented by dashed lines, so that the position of the sidewalls (104) in relation to the cores (103) of the green tire (100) is unchanged. This position of the tire building drum (10) is referred to as the shaping position. Air is introduced into the green tire (100) from inside, so that the middle of the green tire (100) lifts off from the middle part (12) of the tire building drum (10).

The breaker belt assembly (105) is positioned together with the tread (106) on the middle part of the green tire (100).

In FIG. 17, the method step following the method step shown in FIG. 16 of a method according to the invention for producing green tires (100) is shown. The composite made up of the breaker belt assembly (105) and the tread (107) is pressed against the rest of the green tire (100) by means of a pressure-exerting device (51).

FIG. 18 shows the green tire (100) with the pressed-on composite made up of the breaker belt assembly (105) and the tread (106). Furthermore, the sidewalls (104) are pressed against the rest of the green tire (100) by means of the turning-up device (15). For this purpose, in the embodiment shown of a tire building machine, air is introduced into the bladders of the turning-up device (15) from inside and they are thereby expanded, so that the sidewalls (104) are lifted off from the drum halves (11) and they are pressed laterally against the rest of the green tire (100). The core clamping device (14) is active for fixing the green tire (100) on the tire building drum (10).

In FIG. 19, the green tire (100) is shown on the tire building drum (10) after the pressing of the sidewalls (104) against the tire. The turning-up devices (15) are returned by letting air out of the bladders while air is still being introduced into the green tire (100) from inside. The core clamping device (14) is still active.

FIG. 20 shows the completed green tire (100) on the tire building drum (10). The latter is transferred into the region of an unloading device (60). For releasing the green tire (100) for the unloading device (100), the modules (12a) of the middle part (12) of the tire building drum (10) are moved further together, so that the width of the middle part (129 is further reduced. The core clamping device (14) is moved in and air is let out of the green tire (100).

1-7. (canceled)

8. A device for producing a green tire, formed as a tire building machine, comprising: at least one tire building drum; a ply server; a core setting device; at least one turning-up device for turning up at least one ply around a core of the green tire and/or for pressing plies of the green tire against a remainder of the green tire, wherein the tire building drum is arranged on a drum shaft and has a middle part and two drum halves that are movable relative to the middle part in an axial direction of the drum shaft; and a sidewall server configured to simultaneously transfer or lay material of two sidewalls of the green tire onto the drum halves of the tire building drum.

9. The device for producing a green tire according to claim 8, wherein the sidewall server has two sidewall server modules by which in each case the material of one of the sidewalls is transferred onto a drum half of the tire building drum.

10. The device for producing a green tire according to claim 9, wherein the sidewall server modules are arranged at a distance from one another so that a clearance between the sidewall server modules exists in a region of the sidewall server.

11. The device for producing green tires according to claim 9, wherein each of the sidewall server modules has a transporting device for the sidewall material.

12. A method for producing a green tire, comprising the steps of: producing a green tire with a device for producing tires; forming at least one ply of the green tire with a high turn-up; and pressing sidewalls of the green tire against the green tire so that the sidewalls subsequently overlap tread pressed against a remainder of the green tire so that the green tire has a SOT construction.

13. The method according to claim 12, further including the following steps:
a) positioning an inner liner as a first ply of the green tire centrally on a tire building drum;
b) positioning a body ply as a second ply over the first ply centrally on the tire building drum;
c) expanding a middle part of the tire building drum in a radial direction;
d) setting two cores of the green tire using a core setting device;
e) clamping the set cores using a core clamping device;
f) turning up the plies around the cores with at least one turning-up device;
g) placing material for the sidewalls of the green tire onto one drum half each with a sidewall server, wherein the drum halves are positioned at a distance in relation to a middle part of the tire building drum;
h) moving the drum halves toward the middle part, so that the material of the sidewalls in one end region each is positioned under the cores of the green tire;
i) pressing the material of the sidewalls against the green tire under the cores with the core clamping device;
j) introducing air into the green tire;
k) positioning and pressing a breaker belt assembly and a tread against a remainder of the green tire by a pressure-exerting device; and
l) pressing the sidewalls against the green tire by the turning-up device so that in some regions the sidewalls overlap the tread.

14. The method according to claim 12, wherein the device for producing green tires includes: at least one tire building drum; a ply server; a core setting device; at least one turning-up device for turning up at least one ply around a core of the green tire and/or for pressing plies of the green tire against a remainder of the green tire, wherein the tire building drum is arranged on a drum shaft and has a middle part and two drum halves that are movable relative to the middle part in an axial direction of the drum shaft; and a sidewall server configured to simultaneously transfer or lay material of two sidewalls of the green tire onto the drum halves of the tire building drum.
